(19) United States
(12) Patent Application Publication
(10) Pub. No.: US 2024/0092588 A1
(43) Pub. Date: Mar. 21, 2024

(54) APPARATUS FOR IMPLEMENTING A PHYSICAL DISTANCE BETWEEN A GROUP OF CONTIGUOUS PACKAGES AND A SERIES OF ACCUMULATED PACKAGES

(71) Applicant: MAS-PACK S.P.A., San Marzano Cliveto (IT)

(72) Inventors: Gian Luca Scaglione, San Marzano Oliveto (IT); Valter Grasso, San Marzano Oliveto (IT)

(73) Assignee: MAS-PACK S.P.A., San Marzano Cliveto (IT)

(21) Appl. No.: 18/275,846

(22) PCT Filed: Jan. 18, 2022
(86) PCT No.: PCT/IT2022/050004

§ 371 Date: Aug. 4, 2023

(30) Foreign Application Priority Data
Feb. 11, 2021 (IT) 102021000002873

(51) Int. Cl. B65G 47/08; B65G 43/08; B65G 43/10; B65G 47/26; B65G 47/31; B65G 47/32

(52) U.S. Cl. CPC B65G 47/086; B65G 43/08; B65G 43/10; B65G 47/268; B65G 47/31; B65G 47/32

(57) ABSTRACT

An apparatus is described for implementing a physical distance between a group of contiguous packages (1) in continuous advancement on a conveyor belt (3) and a series of accumulated packages (2) on an accumulator belt (4) connected in series to the conveyor belt (3), the apparatus comprising: the conveyor belt (3) driven by a first motor (30); the accumulator belt (4) driven by a second motor (40); a controller (5) of the motion of the accumulator belt (4); first detection means (51) of the group of contiguous packages (1); second detection means (52) of the series of accumulated packages (2); and a robot (6) equipped with gripping means (61) to move the group of contiguous packages (1) on the conveyor belt (3).

### BACKGROUND OF THE INVENTION

### 1) Field of the Invention

The present invention refers to an apparatus for implementing a physical distance between a group of contiguous packages and a series of accumulated packages.

In general, the present invention relates to devices for feeding items or materials to the conveyors for feeding items from a single group of items arranged according to an ordered scheme.

In particular, the present invention relates to a sequential control of conveyor belts operating in combination, to devices that influence the relative position or attitude of the items during transport by the conveyors that arrange the items, for example by varying the distance between the individual items during transport by a series of conveyor belts, varying the relative speeds of the conveyor belts that make up the series.

### 2) Background Art

EP-A1-2749511 relates to a unit for forming a layer of at least one batch having a length L of groups of items, comprising a first conveyor adapted to convey a plurality of groups in a neighboring relationship and driven by a first motor, a second conveyor adapted to separate the batch from the remaining groups for a space, a control unit to control the first motor and thus generate a speed profile of the conveyor, handling means to form the layer and adapted to handle the separated batch on an area defined by the second conveyor, detection means arranged on the second conveyor for detecting the presence of groups on the second conveyor, the detection means being arranged at a distance measured from the end of the second conveyor adjacent to the first conveyor along the direction along which the groups advance, the control unit being configured for updating the fast profile of the conveyor on the basis of the signal generated by the sensing means such that, in the updated configuration, the speed profile of the conveyor is such that the group travels for a length after the sensing means detects the presence of the batch on the conveyor.

EP-A1-1280720 relates to a conveyor induction system comprising a subsystem of a control point for measuring the point at which control of an item passes from one conveyor to another. The induction system also includes a subsystem to precisely create or control gaps between items on the conveyor system. The checkpoint subsystem monitors the position and speed changes of an item as it passes between two conveyor belts operating at different speeds. The gap control subsystem provides real-time monitoring and measurement of packet gaps. The measured packet blanks are fed into a feedback control system which alters the speed of a conveyor in order to modify the blank as desired, a control point determination module comprising a horizontal array of photo detectors comprising a first matrix of photo-emitters and a second series of photo-receptors, the emitters being positioned on an opposite side of the first transporter through and aligned with the receptors. The photo-detector array emits electromagnetic, infrared or other signals, from the emitters through the first carrier to the receptors that detect the emitted signal, provided that there is no item on the first carrier that obstructs the line of sight between an emitter and a receptor. The array of photodetectors is then able to determine where the spaces between items are, by determining which particular photodetectors are not obstructed at any given time. The horizontal array of photodetectors can be of any type of conventional array of photodetectors, such as those commercially available. The photodetector array should include photodetectors that are spaced relatively close together, so that accurate information about the location of the gaps and the location of items traveling on the first conveyor can be collected. While other distances are within the scope of the invention, a photodetector positioned every five millimeters along the length of the horizontal array is contemplated. More compactly spaced photo detectors would provide more accurate information about the location of items and gaps, if all other factors remained the same.

The array is located next to a portion of the first conveyor, a portion of the second conveyor and the space between the first conveyor and the second conveyor. The array preferably, although not necessarily, extends for a distance equal to the maximum expected length of the items to be transported. A gap detector receives the output from the array and uses it to determine the gap or spaces between items traveling within the array's detection zone. The gap detector detects these gaps by determining which individual photodetectors are blocked by items and which are not. Based on the number of photodetectors that are not obstructed between items or the distance between the set of continuous photodetectors, the length of a gap can be determined. Further, by determining which individual photodetectors are unobstructed, the position of the gap relative to the first conveyor can be determined based on the known position of each of the photodetectors.

Therefore, EP-B1-1280720 relates to a conveyor induction system comprising a first conveyor with adjustable speed, a second conveyor aligned with the first conveyor with adjustable speed and operable at a different speed than the first conveyor, a controller that emits a control for adjusting the speed of the first conveyor at adjustable speed in order to adjust a desired space between a first item and a second item as it travels on the first conveyor and on the second conveyor. A sensor repeatedly measures each space between a first item and a second item while the first item is at least partially positioned on the first adjustable speed conveyor and the second item is positioned on the second conveyor, the controller being a feedback controller that receives information from the sensor, calculating any difference between the measured gap and a desired gap, to allow at the output to regulate the speed of the conveyor with adjustable speed according to any difference between the measured space and the desired one.

EP-A1-2107018 discloses an apparatus according to the preamble of claim 1.

The inventive solution of EP-A1-2749511 solves the problem of controlling the size and distance of a batch separated by groups of batches by counting the revolutions of the motor that moves a conveyor belt, starting from the detection of the transit of a front of batches, by means of the detection means positioned on the first and on the second conveyor belt. However, this solution does not allow the real-time control of the position of the separated batch, becoming critical in the presence of sliding of the batch compared to the fact that it may have lost adherence especially during the transfer from a conveyor belt to the conveyor belt characterized by different speeds and different friction conditions.

The solution to this problem is given by EP-A1-1280720 by means of which the position of the batch straddling the two conveyors is checked in real time, by means of a linear photoelectric detection matrix which, in addition to solving the control problem of the batch sliding on the belt, does not need to count the number of revolutions of the belt drive motor.

However, the solution of EP-A1-1280720 could be further simplified for a system consisting of an accumulator of batches without empty spaces, and a dispenser of a certain number of batches that are physically separate from the accumulated batches.

For this type of system, it is possible to concentrate the control in real time only on the conveyor belt, since, due to the intrinsic nature of a conveyor belt, the batches are contiguous and therefore without physical space. Therefore, after having guaranteed the accumulation condition on the conveyor belt, by means of object detectors, the real-time control is only needed on the conveyor belt where the conditions of reduced friction lead to sliding.

The real-time control made possible by linear matrix detectors of photoelectric sensors is suitable for optimizing the energy yield of the transport system by establishing a control of the electrical absorption of the motors distributed throughout the transport system. The start-up stop steps of the accumulation and transport belts can be optimized by varying the inclination of the respective deceleration and acceleration ramp. In case of heavy batches, the management of start and stop times becomes important to avoid overloading the electrical circuitry of the belt motors. By measuring the electrical absorption of the motors, it is possible to define an optimal ramp from the nominal speed value to the null value and vice versa. This optimal ramp profile value is a function of the length of the high friction belt section, as well as the weight of the supported batches, considering that, during the acceleration and deceleration ramp, the batches on the high friction belt are called to push the batches that are entering the area of the low friction belt.

### SUMMARY OF THE INVENTION

Object of the present invention is solving the aforementioned prior art problems by providing an apparatus for implementing a physical distance between a group of contiguous packages and a series of accumulated packages which allows preparing the packages to be palletized by means of a robot of a line fed in continuous from contiguous packages.

A further object of the present invention is providing an apparatus for implementing a physical distance between a group of contiguous packages and a series of accumulated packages which allows optimizing the dynamic behavior of the package feeding line to limit the electrical absorption overload in relation to the size and weight of the packages.

The afore and other objects and advantages of the invention, as will emerge from the following description, are achieved with an apparatus for implementing a physical distance between a group of contiguous packages and a series of accumulated packages, such as that described in claim 1. Preferred embodiments and non-trivial variations of the present invention are the subject matter of the dependent claims.

It is understood that all attached claims form an integral part of the present description.

It will be immediately obvious that innumerable variations and modifications (for example relating to shape, dimensions, arrangements and parts with equivalent functionality) can be made to what is described, without departing from the scope of the invention as appears from the attached claims.

### BRIEF DESCRIPTION OF THE DRAWINGS

The present invention will be better described by some preferred embodiments thereof, provided by way of non-limiting example, with reference to the attached drawings, in which:

FIG. 1 shows a functional diagram of an apparatus embodiment to implement a physical distance between a group of contiguous packages and a series of accumulated packages, according to the present invention;

FIG. 2 shows a functional diagram of a further embodiment of the apparatus to implement a physical distance between a group of contiguous packages and a series of accumulated packages, according to the present invention;

FIG. 3 shows an enlarged portion III of the previous figure; and

FIG. 4 shows a relevant part of the previous figure, in different functional configurations of an apparatus embodiment to implement a physical distance between a group of contiguous packages and a series of accumulated packages, according to the present invention.

### DETAILED DESCRIPTION OF PREFERRED EMBODIMENTS

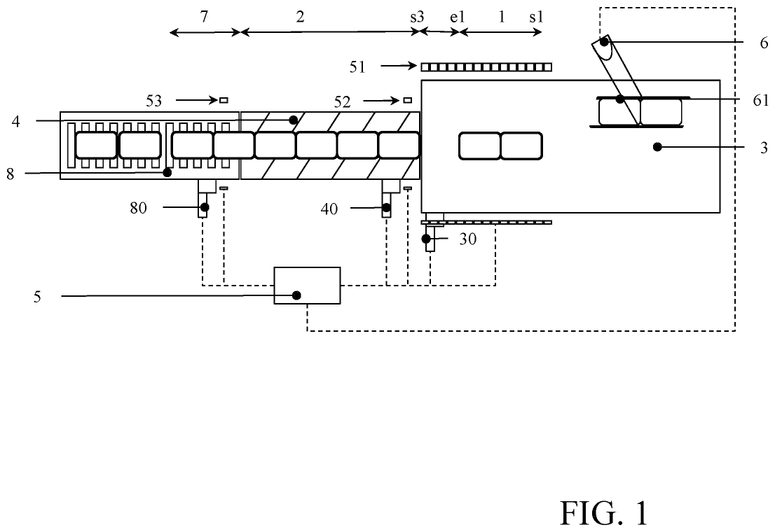

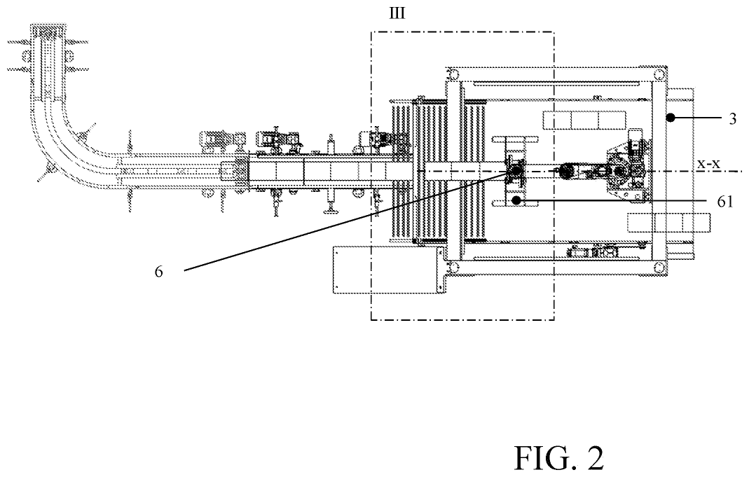

Referring to FIG. 1 and FIG. 2, it is possible to note an apparatus for implementing a physical distance between a group of contiguous packages 1 and a series of accumulated packages 2, the group of contiguous packages 1 being in continuous advancement on a conveyor belt 3 driven by a first motor 30, the series of accumulated packages 2 being provided to fill an accumulator belt 4 driven by a second motor 40 and connected in series to the conveyor belt 3, this apparatus comprising a controller 5 of the motion of the accumulator belt 4 by means of first detection means 51 of the group of contiguous packages 1 and second detection means 52 of the series of accumulated packages 2.

Advantageously, the first detection means 51 of the group of contiguous packages 1 are capable of continuously acquiring the dimension comprised between a start s1 and an end e1 along the direction of advancement and the physical distance between the end e1 and an inlet s3 of the belt conveyor 3, to allow the motion of the accumulator belt 4 to be synchronized with that of the conveyor belt 3, during the acquisition of the dimension between a start s1 and an end e1, and to allow the motion of the accumulator belt 4 to be stopped during acquisition of the physical distance between the end e1 and the entrance s3.

The group of contiguous packages 1 is moved by means of gripping means 61 of a robot 6 on the conveyor belt 3 having a first friction (reduced friction); the series of accumulated packages 2 is provided to fill the accumulator belt 4 having a second friction (high friction) greater than the first friction; the series of accumulated packages 2 is fed by a series of sliding packages 7 on at least one variable friction mobile belt 8 driven by a third motor 80 and equipped with third detection means 53 of the series of sliding packages 7.

Preferably, the conveyor belt 3 is smooth, the accumulator belt 4 is rubberized, the mobile belt 8 is a chain with idle rollers.

During the acquisition of the dimension between the start s1 and the end e1, the controller 5 allows to set a deceleration ramp of the accumulator belt 4, as function of a reference value of the electric deceleration absorption A40− of the second motor 40; moreover, during the acquisition of the physical distance between the end e1 and the input s3, the controller 5 allows to set an acceleration ramp of the accumulator belt 4, as a function of a reference value of electrical acceleration absorption A40+ of the second motor 40.

Preferably, the electrical deceleration absorption reference value A40− corresponds to the updated electrical deceleration absorption measurement in a previous dimensional acquisition, just as the electrical acceleration absorption reference value A40+ of the second motor 40 corresponds to the updated measurement of electrical acceleration absorption in a previous acquisition of the physical distance.

Referring to FIG. 1, it is possible to note that the first detection means 51 of the group of contiguous packages 1 consist of a photoelectric barrier composed of an emitter unit and a receiver unit, developed along the advancement direction, which can be used for measuring objects, synchronization between the two units being able to take place optically or via cable. The second detection means 52 of the series of accumulated packages 2 and the third detection means 53 of the series of sliding packages 7 consist of a photoelectric barrier composed of an emitter unit and a receiver unit, usable for detecting objects.

Referring to FIG. 2, it is possible to note that, in a further configuration, both the first detection means 51 of the group of contiguous packages 1, and the second detection means 52 of the series of accumulated packages 2, consist of a photoelectric barrier composed of an emitter unit and of a receiver unit, developed along the advancement direction, usable for measuring objects, the synchronization between the two units being able to take place optically or via cable, while the third detection means 53 of the series of sliding packages 7 consist of a barrier photoelectric unit consisting of an emitter unit and a receiver unit, which can be used for object detection.

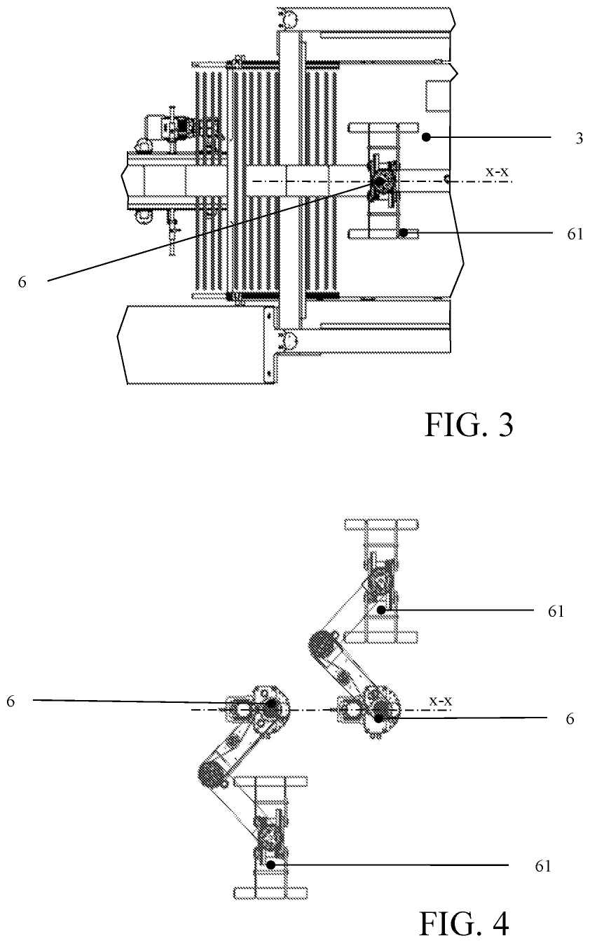

Referring to FIG. 3 and FIG. 4, it is possible to note that the gripping means 61 of the robot 6 are able to stand in wait for the group of contiguous packages 1 and to travel a length along the advancement direction of the conveyor belt 3 to move the group of contiguous packages 1.

The robot 6 lies on the center line x-x of the conveyor belt 3 in order to optimize a path to move the group of contiguous packages 1.

As examples of use, the following can be made.

A carton feeder for transporting cartons/boxes/packages with an advancement direction which can be in the short side or long side.

A carton transport A with roller chain for accumulation and a transport of cartons B with smooth belt. There are two photocells ft1, ft2 on transport A. When the cartons engage photocell ft2, after a delay they determine the start of transport B. Transport B stops if photocell ft2 disengages. The photocell ft1 is used to increase the speed. When the cartons reach and engage the photocells ft3, ft4, they determine the start of transport C, rubberized belt.

A transport of cartons C with rubber mat. With the engagement of the photocells ft2, ft3, ft4, the continuous advancement of the cartons from B to C takes place until the photocell ft5 is engaged. As long as a photocell ft5 is not engaged, the conveyors A, B, C remain active.

The motors of the transport C, D, move at a controlled speed to have the synchronism of the advancement of the cartons. A photocell ft6 detects the start of the carton to determine the length of the trial, made up of one, two or more cartons, and, once the length has been reached, it will stop the conveyor C to obtain a distance between one trial and the next, after which the start of the conveyor C will be repeated, always if the photocells from ft2 to ft5 are engaged.

A transport of cartons D with smooth belt. Conveyor always in operation, unless there are alarms, on which the plane is formed according to the palletization scheme.

In this station there is a robot that, with a gripper, manipulates the cartons that are received according to a specific program to obtain the required palletization scheme.

We claim:

1. An apparatus for implementing a physical distance between a group of contiguous packages in continuous advancement on a conveyor belt and a series of accumulated packages on an accumulator belt connected in series to the conveyor belt, the apparatus comprising:
the conveyor belt having a first friction, i.e. a reduced friction, driven by a first motor;
the accumulator belt having a second friction, i.e. a high friction, higher than the first friction, the accumulator belt being driven by a second motor;
a controller of z motion of the accumulator belt;
first detection means of the group of contiguous packages capable of continuously acquiring a dimension comprised between a start and an end along a direction of advancement and a physical distance between the end and an inlet of the conveyor belt;
second detection means of the series of accumulated packages, the series of accumulated packages fed by a series of packages sliding on at least one movable belt with variable friction, the movable belt being driven by a third motor and equipped with third sensing means of the series of sliding packages;
a robot equipped with gripping means to move the group of contiguous packages on the conveyor belt;
wherein at least the first detection means of the group of contiguous packages consist of a photoelectric barrier composed of an emitter unit and a receiver unit, developed along the forward direction, which can be used for measurement of objects, a synchronization between the two units being designed to take place optically or via cable.

2. The apparatus of claim 1, wherein the conveyor belt is smooth, the accumulator belt is rubberized, and the movable belt is a chain with idle rollers.

3. The apparatus of claim 1, wherein, during an acquisition of the dimension comprised between the start and the end, the controller is designed to set a deceleration ramp of the belt accumulator, as a function of a reference value of electrical deceleration absorption of the second motor, and, during the acquisition of the physical distance between the end and the input, the controller is designed to set an acceleration ramp of the accumulator belt, as a function of an electrical acceleration absorption reference value of the second motor.

4. The apparatus of claim 3, wherein the reference value of electrical deceleration absorption corresponds to the updated measure of electrical deceleration absorption in a previous acquisition of the dimension, as well as the reference value of electrical acceleration absorption of the second motor corresponds to the updated measurement of electrical acceleration absorption in a previous acquisition of the physical distance.

5. The apparatus of claim 1, wherein the second detection means of the series of accumulated packages consist of a photoelectric barrier composed of an emitter unit and a receiver unit, developed along the advancement direction, usable for measuring objects, synchronization between the two units being able to take place optically or via cable, and the third detection means of the series of sliding packages consist of a photoelectric barrier consisting of an emitter unit and a receiver unit, which can be used for object detection.

6. The apparatus of claim 1, wherein the gripping means of the robot are provided for stationary waiting for the group of contiguous packages and to travel a section along the direction of advancement conveyor belt to move the group of contiguous packages.

7. The apparatus of claim 6, wherein the robot lies on a centerline of the conveyor belt in order to be able to optimize a path for moving the group of contiguous packages.
